(19) United States
(12) Patent Application Publication
(10) Pub. No.: US 2010/0161844 A1
(43) Pub. Date: Jun. 24, 2010

(54) DMA compliance by remapping in virtualization

(75) Inventors: Kaushik Barde, Sunnyvale, CA (US); Matthew Ryan Laue, Palo Alto, CA (US)

Correspondence Address: PHOENIX TECHNOLOGIES LTD., 915 MURPHY RANCH ROAD, MILPITAS, CA, 95035, US

(73) Assignee: PHOENIX TECHNOLOGIES LTD

(21) Appl. No.: 12/317,648

(22) Filed: Dec. 23, 2008

(51) Int. Cl. G06F 13/28; G06F 9/455

(52) U.S. Cl. 710/22; 718/1

(57) ABSTRACT

Methods, systems, apparatuses and program products are disclosed for managing DMA compliance by remapping in hypervisor and hypervisor-related environments.

### FIELD OF THE INVENTION

The present invention generally relates to personal computers and devices sharing similar architectures, and, more particularly relates to a system and method for enabling and facilitating DMA (Direct Memory Access) transfers to and from programs that run in virtualized environments.

### BACKGROUND OF THE INVENTION

Modernly, the use of virtualization is increasingly common on personal computers. Virtualization is an important part of solutions relating to energy management, data security, hardening of applications against malware (software created for purpose of malfeasance), and more.

One approach, taken by Phoenix Technologies® Ltd., assignee of the present invention, is to provide a small hypervisor (for example the Phoenix® HyperSpace™ product) which is tightly integrated to a Linux® based kernel that hosts a relatively few small and hardened application programs. HyperSpace™ also hosts, but is only loosely connected to, a full-featured general purpose computer environment or O/S (Operating System) such as Microsoft® Windows Vista® or a similar commercial product, this is termed the GOS (guest operating system).

By design, HyperSpace™ supports only one guest O/S per operating session together with at least one Open Source based operating system.

I/O device emulation is commonly used in hypervisor based systems such as the open source Xen® hypervisor. Use of emulation, including I/O emulation, can result in a substantial performance hit and that is particularly undesirable in regards to resources for which there is no particular need to virtualize and/or shared and for which therefore emulation offers no great benefits.

Some I/O devices use DMA (Direct Memory Access) which is a technique for autonomous transfers between peripherals and memory. DMA-capable peripherals come with a legacy including various constraints that must be accommodated and which created implementation problems in virtualized environments.

### SUMMARY OF THE INVENTION

The present invention provides a method of executing a program for DMA (Direct Memory Access) compliance by remapping and also apparatus(es) that embodies the method. In addition program products and other means for exploiting the invention are presented.

According to an aspect of the present invention an embodiment of the invention may provide for a method of executing programs comprising loading a hypervisor above a threshold address, for example a 16 Mbyte physical address in RAM (Random Access Memory). It may further provide for loading a DMA-capable operating system program into low memory such as by reading from non-volatile storage (such as Flash memory) into physical and/or linear addresses below a threshold address, such as 16 MByte. It may also provide for performing the DMA transfers such as to and/or from PCI (peripheral component interconnect) connected peripherals, for example DVD™ (Digital Versatile Disc). DVD™ is a trademark of The DVD Forum.

The disclosed invention includes, among other things, methods and techniques for providing DMA capabilities while simultaneously allowing the virtualization and/or emulation of other devices and/or resources.

Thus, the disclosed improved computer designs include embodiments of the present invention enabling superior tradeoffs in regards to the problems and shortcomings outlined above, and more.

### BRIEF DESCRIPTION OF THE DRAWINGS

The aforementioned and related advantages and features of the present invention will become better understood and appreciated upon review of the following detailed description of the invention, taken in conjunction with the following drawings, which are incorporated in and constitute a part of the specification, illustrate an embodiment of the invention and in which:

FIG. 1 is a schematic block diagram of an electronic device configured to implement the remapped DMA functionality according to an embodiment of the invention of the present invention.

FIG. 2 shows with particularity certain components and dataflows within the electronic device involved in a DMA transfer according to an embodiment of the present invention.

FIG. 3 is a block diagram that shows the architectural structure of the software components of a typical embodiment of the invention.

FIG. 4A shows a physical memory layout according to an embodiment of the invention.

FIG. 4B is a flowchart that shows a method according to an embodiment of the invention.

FIG. 5 shows how an exemplary embodiment of the invention may be encoded onto computer medium or media.

FIG. 6 shows how an exemplary embodiment of the invention may be encoded, transmitted, received and decoded using electromagnetic waves.

For convenience in description, identical components have been given the same reference numbers in the various drawings.

### DETAILED DESCRIPTION OF THE PREFERRED EMBODIMENTS

An exemplary embodiment of the present invention is described below with reference to the figures.

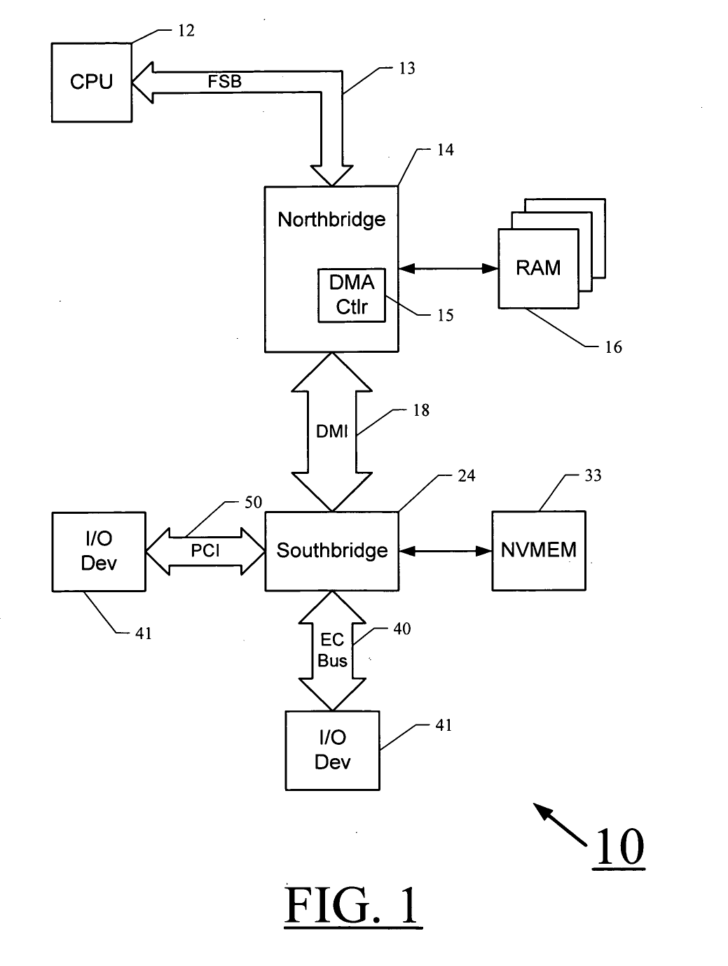

FIG. 1 is a schematic block diagram of an electronic device configured to implement the remapped DMA functionality according to an embodiment of the invention of the present invention.

In an exemplary embodiment, the electronic device 10 is implemented as a personal computer, for example, a desktop computer, a laptop computer, a tablet PC or other suitable computing device. Although the description outlines the operation of a personal computer, it will be appreciated by those of ordinary skill in the art, that the electronic device 10 may be implemented as other suitable devices for operating or interoperating with the invention.

The electronic device 10 may include at least one processor or CPU (Central Processing Unit) 12, configured to control the overall operation of the electronic device 10. Similar controllers or MPUs (Microprocessor Units) are commonplace.

The processor 12 may typically be coupled to a bus controller 14 such as a Northbridge chip by way of a bus 13 such as a FSB (Front-Side Bus). A Northbridge chip 14 may typically provide an interface for read-write system memory 16 such as semiconductor RAM (random access memory). A Northbridge chip 14 may also provide a DMA (Direct Memory Access) controller circuit 15 for memory access, typically to or from a peripheral device.

The bus controller 14 may also be coupled to a system bus 18, for example a DMI (Direct Media Interface) in typical Intel® style embodiments. Coupled to the DMI 18 may be a so-called Southbridge chip such as an Intel® ICH8 (Input/Output Controller Hub type 8) chip 24. A DMI 18 may be used for data transfers using PIO (programmed input-output) which may be to or from the CPU 12 or RAM 16 via DMA controller 15.

In a typical embodiment, the SouthBridge chip 24 may be connected to a PCI (peripheral component interconnect) bus 22 and an EC Bus (Embedded controller bus) 23 each of which may in turn be connected to various input/output devices (not shown in FIG. 1). In a typical embodiment, the SouthBridge chip 24 may also be connected to at least one form of NVMEM 33 (non-volatile read-write memory) such as a Flash Memory and/or a Disk Drive memory.

In typical systems the NVMEM 33 will store programs, parameters such as firmware steering information, O/S configuration information and the like together with general purpose data and metadata, software and firmware of a number of kinds.

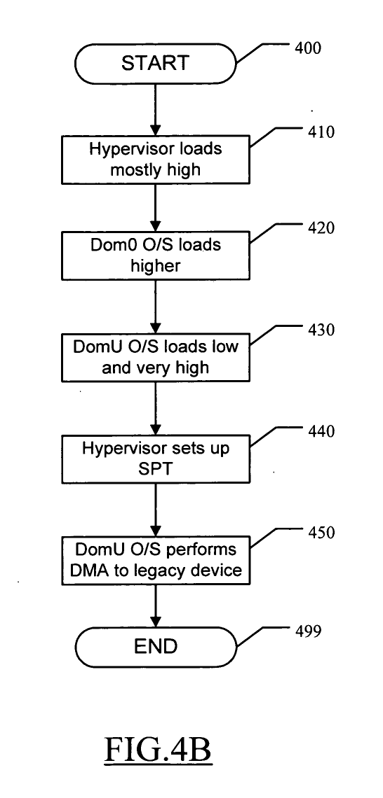

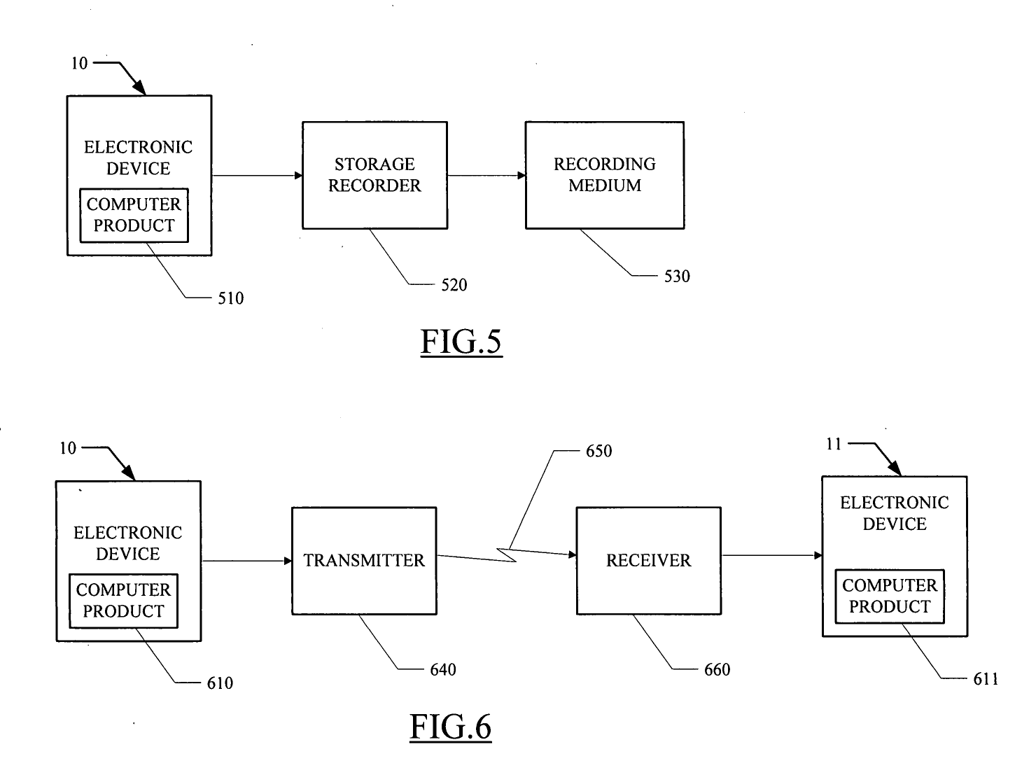

Storage recorders and communications devices including data transmitters and data receivers may also be used (not shown in FIG. 1, but see FIGS. 5 and 6) such as may be used for data distribution and software distribution in connection with distribution and redistribution of executable codes and other programs that may embody the parts of invention.

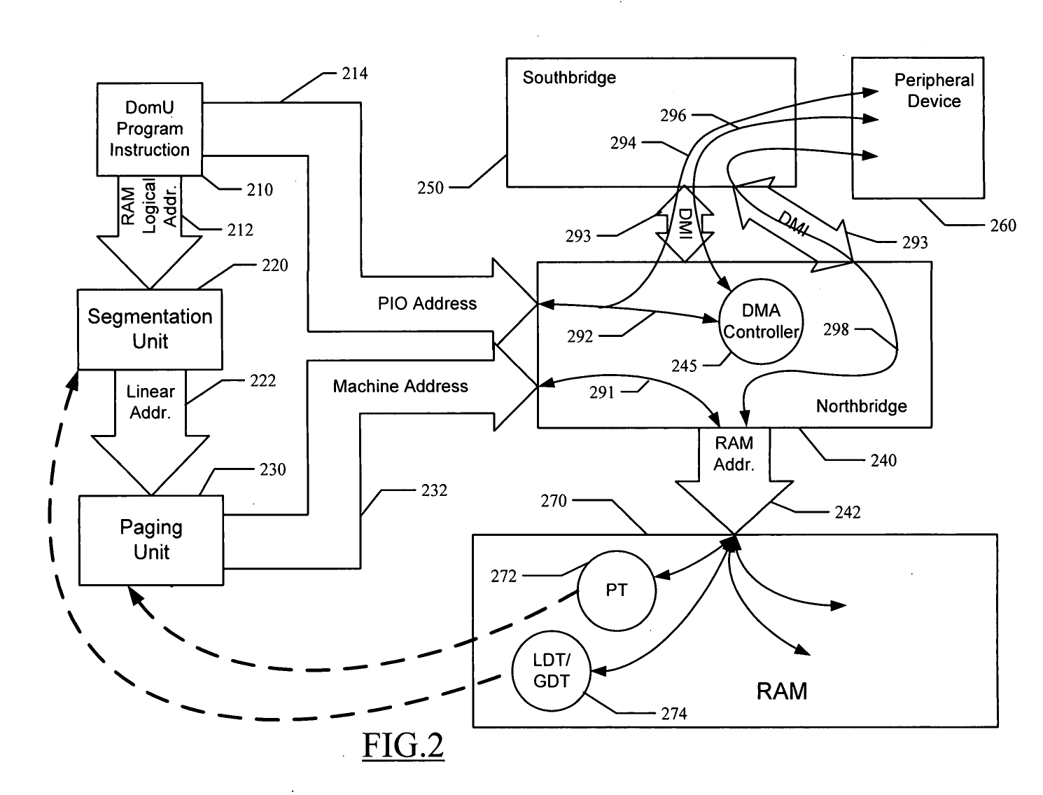

FIG. 2 shows with particularity certain components and dataflows within the electronic device involved in a DMA transfer according to an embodiment of the present invention.

Referring to FIG. 2, DomU program instructions 210 in an instruction register (not shown), having been previously fetched from RAM 270, are operable to generate RAM logical addresses 212 which are passed to the segmentation unit 220 (all are comprised within a CPU—not expressly shown in FIG. 2). The term DomU is well known in the Xen®/hypervisor arts to refer to a so-called Unprivileged Domain within a hypervisor, see further below for more information on DomU. PIO (programmed input-output) addresses 214 may also be generated by the DomU program instructions 210.

The segmentation unit 220 uses information from the LDT/GDT 274 (Local Descriptor Table and/or Global Descriptor Table) to generate a corresponding linear address 222. In the Flat programming model, which is widely adopted, the RAM logical addresses 212 and linear addresses 222 may be cardinally equal, however the two segment descriptor tables 274 provide additional segment-based information such as memory access privilege information. The extents to which segmentation is provided and the exact manner in which it is operates vary among implementations (especially exact types of CPU including multi-processor implementations).

The linear address is translated by the paging unit 230 generating a machine address 232. The operation of the paging unit 230 is steered by information from the PT (Page table(s)) 272 located in RAM 270 to perform the translation from (virtual) linear address to physical address. A physical address is also commonly known as a machine address though the two can be separated in certain more advanced implementations.

Leaving the CPU, the physical address 232 and PIO address 214 reach the Northbridge chip 240. In the case of a RAM transaction 291, all or part of a physical address from the paging unit 230, for example, is used as the RAM address 242.

Also comprised within the Northbridge chip 240 is the DMA controller 245. The DMA controller 245, may be addressed to receive programmed I/O commands 292 by program instructions in DomU 210.

PIO commands may also be sent (from DomU 214) to the Southbridge chip 250 via the DMI 293 (Direct Media Interface) which commands may then be forwarded 294 to any of a number of peripheral devices 260.

Still referring to FIG. 2, a description of an exemplary DMA transaction will now be given. A first step is to program the DMA controller 245 by sending commands to it using its PIO address 214. The DMA controller can then communicate 296 in turn to set up a DMA-capable peripheral device 260. The peripheral device 260 may also receive PIO commands 294 directly without involving the DMA controller 245. The peripheral device 260 may be given an address in RAM 270 to or from which the data transfer take place 298, without directly without involving the CPU.

Transfers, as described above, were developed to operate correctly outside a virtualization environment. However, the use of virtualization creates a particular potential problem in a hypervisor context which may be addressed in part by the present invention. In particular, peripheral devices 260 often have legacy design constraints that limit their addressing capabilities. It may be crucial that such design constraints are not violated.

A particularly common constraint is that peripheral devices 260, especially devices connected via a PCI (peripheral connection interface) are limited to generating addresses that can be expressed in 24 bits, that is a range of 16 Mebibytes, which limitation originated with a number of address circuits in the Intel® model 80286 microprocessor products. As a result, if the DomU program is loaded such that DMA data areas fall above a 16 Mebibyte address limit, then such addresses are subject to truncation (such as within the peripheral device hardware circuitry) in some cases since the peripheral device 260 cannot understand such high addresses.

There may even be legacy devices that cannot cope with more than a 20 bit address space (1 Mebibyte address range) and which are not yet entirely obsolete.

The unit Mebibyte is well known in the art and defined in IEEE 1541-2002 (Institute of Electrical and Electronics Engineers standard 1541-2002) and endorsed by CIPM (Comité international des poids et measures). It is equivalent to 1048576 bytes of information and said to be a contraction of “Mega Binary Byte”.

In order to overcome such problems, it is desirable that DMA data areas created by the DomU program are not located above the 16 Mebibyte address limit, reflecting a 24-bit addressing limitation. Indeed, it is desirable that DMA data areas fall more or less in the same locations that they would fall if the DomU operating system program were loaded and were operating without any Hypervisor program being present at all. This reflects the situation that certain complex O/S (operating system) products have developed various means to handle legacy DMA devices, but those means typically rely on certain crucial parts of operating system's data space being located in memory having particularly low physical addresses.

Moreover, the legacy of O/S product development to cater for limited addressing capabilities of DMA devices persists even where more modern DMA techniques are used. More modern alternatives to traditional DMA are well-known in the art but O/S implementations have continued to be compromised by legacy considerations. Guest O/S programs, such as may typically be deployed into DomU in embodiments of the invention, may have been developed to cater for such DMA hardware and firmware product limitations and may then fail to operate properly in virtualized environments even in the absence of DMA-capable devices if the virtualized environment fails to honor and fully replicate limitations reflected in supported memory maps. Thus a need to replicate the availability of traditionally placed low memory for use by the guest O/S may exist.

Commonly, more modern O/S products that target PC BIOS X86 environments may use a well-known memory resource information scheme informally known in the art as “E820”. The E820 technique for locating memory that becomes a central part of a DomU O/S working set typically uses a software interrupt (real mode INT 15h, AX=E820h) and an exemplary implementation that approximates canonical status is reproduced as Exhibit 1 (in-line, below). Thus, in at least some implementations, the hypervisor program and/or Dom0 must provide suitable low memory to enable the guest O/S to “load into low memory” as described below by means of notifying DomU of the availability of suitable low memory allocations by providing an E820 service to the guest O/S. Allocating memory using E802 schemes are well-known in the art. The guest O/S need not be aware it is running in a virtualized environment and that the E820 memory service is provided by the hypervisor and/or Dom0 instead of by the BIOS.

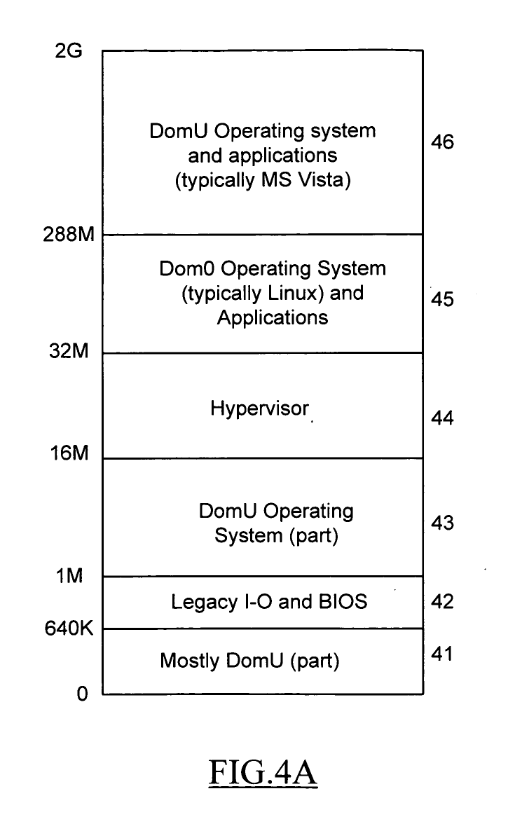

According to an embodiment of the invention this very requirement is achieved, in part, by loading the Hypervisor program at relatively high addresses as described below in connection with FIG. 4B and thereby avoiding premature preemption of certain addresses that are particularly critical in a context of DMA.

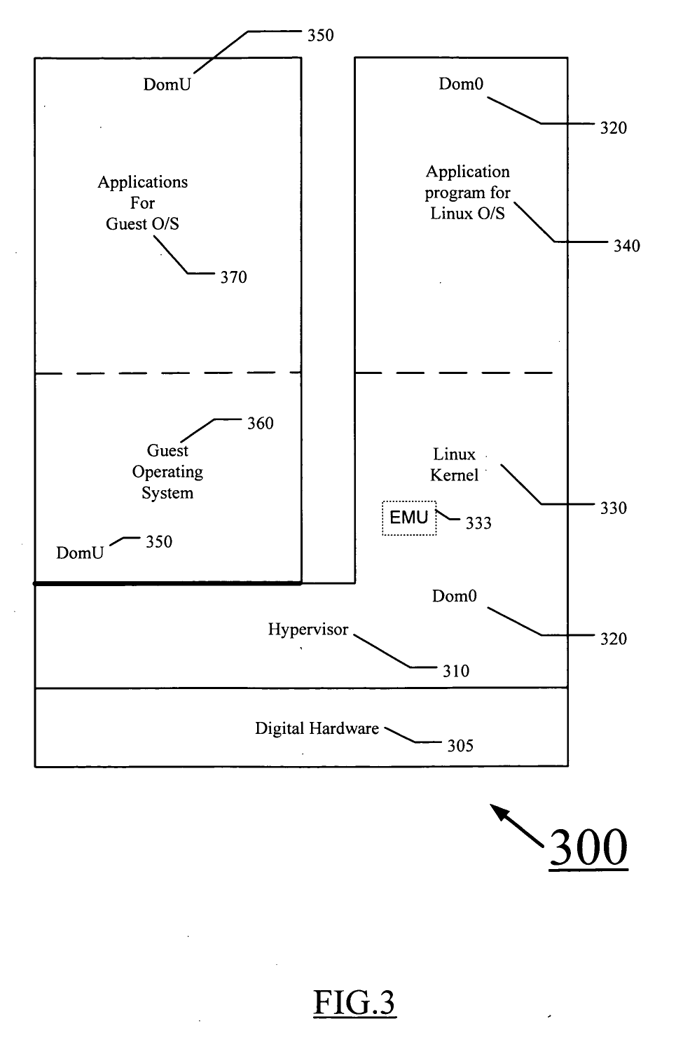

FIG. 3 is a block diagram that shows the architectural structure 300 of the software components of a typical embodiment of the invention. FIG. 3 does not represent layout order or even juxtaposition in physical memory, rather it illustrates software architectural interrelationship in an exemplary embodiment of the invention. Other arrangements are entirely possible within the general scope of the invention.

The hypervisor 310 is found near the bottom of the block diagram to indicate its relatively close architectural relationship with the computer hardware 305. The hypervisor 310 forms an important part of Dom0 320, which (in one particular embodiment of the invention) is a modified version of an entire Xen® and Linux® software stack.

Within Dom0 lies the Linux® kernel 330 program, upon which the applications 340 programs for running on a Linux® kernel may be found.

Also within the Linux kernel 330 lies EMU 333 (I/O emulator subsystem) which is a software or firmware module whose main purpose is to emulate I/O (Input-Output) operations.

Generally speaking, the application program (usually only one at a time) within Dom0 runs in a relatively privileged CPU mode, and such programs are relatively simple and hardened applications in a typical embodiment of the invention. CPU modes and their associated levels of privilege are well known in the relevant art.

Dom0 is thus, in a typical embodiment of the invention, a privileged domain. That is to say that Dom0 runs in a privileged CPU mode, for example Ring 0 in an IA-32 architecture. In one embodiment, Dom0 comprising the hypervisor, Linux® kernel including I-O emulation features, and hardened applications.

Also running under the control of the hypervisor 310 are the untrusted domain—DomU 350 softwares. Within the DomU 350 may lie the guest O/S 360, and under the control of the guest O/S 360 may be found (commonly multiple instances of) applications 370 that are compatible with the guest O/S.

FIG. 4A shows a physical memory layout according to an embodiment of the invention. The lowest region of RAM 41 from byte address 0 to 640 kBytes is low memory and is given over to DomU, in large part.

The region of RAM 42 from 640 kilobytes to 1 Mebibyte is devoted to legacy input output regions and BIOS regions and the like.

The next region of RAM 43 from address 1 Mebibyte to address 16 Mebibyted is given to the DomU operating system. The DMA data areas may typically be found in this region, although they may also be in low memory in some instances.

The following region of RAM 44 from addresses 16 Mebibytes to 32 Mebibytes is devoted to the Hypervisor, which is a core component of the Dom0 domain.

The region of RAM 45 from 32 Mebibytes to 288 Mebibytes is given to the Dom0 operating system which is typically the Linux® kernel and applications designed to interoperate with a Linux® kernel.

The remainder of physical memory space 46, which may in some implementations end out around address up to the 2 Gbytes is given to the DomU operating system and the applications designed to interoperate with it. The DomU operating system in one particular embodiment is the Microsoft® Vista® product.

The above description of the exemplary memory layout illustrated by FIG. 4A relates to RAM layout in terms of physical memory addresses rather than virtual memory or logical addresses.

FIG. 4B is a flowchart that shows a method according to an embodiment of the invention.

The method starts at box 400. At box 410 the hypervisor is loaded into a relatively high address, this hypervisor memory datum byte physical address is a threshold address. In an embodiment it will typically be at 16 Mebibytes or just a little higher. In practice, the hypervisor is typically a part of a Dom0 privileged operating system program and may be loaded as a contiguous part of it.

At Box 420 the Dom0 operating system is loaded at a privileged operating system memory datum byte physical address higher than the hypervisor in memory. Typically, but not necessarily, the hypervisor will occupy something on the order of 16 MB of memory, and the Dom0 operating system will be a version of Linux® operating system together with space for its application programs may occupy perhaps somewhere between 128 Mebibytes and 256 MebiBytes. In an alternative embodiment of the invention the locations in memory of the hypervisor and the Dom0 operating system make be reversed such as with hypervisor loaded at an address that permits Dom0 operating system to load neatly below it. Other functionally equivalent arrangements will be apparent to persons of ordinary skill in the relevant art.

At box 430 the DomU operating system is loaded. Typically, the DomU operating system will be a large fully featured operating system, such as the Microsoft® Windows® operating system software product. The DomU operating system will typically require substantially all the remaining RAM, including the physical memory addresses below the threshold (typically 16 MB) and perhaps at least a gigabyte or so of RAM located at high or very high datum byte physical addresses. By allocating the DomU operating system substantially all the memory at physical addresses below the threshold (e.g. 16 MB) the DomU operating system is able to allocate DMA data transfer areas in traditionally low memory addresses.

At box 440, the hypervisor sets up SPT (shadow page tables). Techniques for the use of SPTs are well-known in the hypervisor arts when implementing HVM (hardware virtual machines). The DomU operating system may, and typically will, perform a complex initialization procedure and run programs at this point, however such activity is not an essential part of the invention.

At box 450 the DomU operating system performs DMA to a peripheral, which may be, but need not be, a legacy device. And at box 499 the method is completed.

FIG. 5 shows how an exemplary embodiment of the invention may be encoded onto a computer medium or media.

With regards to FIG. 5, computer instructions to be incorporated into in an electronic device 10 may be distributed as manufactured firmware and/or software computer products 510 using a variety of possible media 530 having the instructions recorded thereon such as by using a storage recorder 520. Often in products as complex as those that deploy the invention, more than one medium may be used, both in distribution and in manufacturing relevant product. Only one medium is shown in FIG. 5 for clarity but more than one medium may be used and a single computer product may be divided among a plurality of media.

FIG. 6 shows how an exemplary embodiment of the invention may be encoded, transmitted, received and decoded using electromagnetic waves.

With regard to FIG. 6, additionally, and especially since the rise in Internet usage, computer products 610 may be distributed by encoding them into signals modulated as a wave. The resulting waveforms may then be transmitted by a transmitter 640, propagated as tangible modulated electromagnetic carrier waves 650 and received by a receiver 660. Upon reception they may be demodulated and the signal decoded into a further version or copy of the computer product 611 in a memory or other storage device that is part of a second electronic device 11 and typically similar in nature to electronic device 10.

Other topologies devices could also be used to construct alternative embodiments of the invention.

The embodiments described above are exemplary rather than limiting and the bounds of the invention should be determined from the claims. Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims. For purposes of clarity and conciseness of the description, not all of the numerous components shown in the schematics, charts and/or drawings are described. The numerous components are shown in the drawings to provide a person of ordinary skill in the art a thorough, enabling disclosure of the present invention.

The description of well-known components is not included within this description so as not to obscure the disclosure or take away or otherwise reduce the novelty of the present invention and the main benefits provided thereby.

EXHIBIT 1 - Exemplary E820 code

```
struct e820map {
    int nr_map;
    struct e820entry {
        /* start of memory segment */
        unsigned long long addr;
        /* size of memory segment */
        unsigned long long size;
        /* type of memory segment */
    unsigned long type;
    } map[E820MAX];
};
doE820code:
    movw $E820MAP, %di # Desired offset in zero page
    jmpe820:
    movl $0x0000e820, %eax # BIOS function number
    movl $SMAP, %edx # Ascii ’SMAP’
    movl $20, %ecx # Size of a map element
    pushw %ds
    popw %es
    int $0x15 # Invoke BIOS service
good820:
    movb (E820NR), %al
    cmpb $E820MAX, %al # Check for max entries
    jnl bail820
    incb (E820NR) # Bump up entry counter
    movw %di, %ax
    addw $20, %ax
    movw %ax, %di
again820:
    cmpl $0, %ebx # Are we at the last entry?
    jne jmpe820
```

What is claimed is:

1. A method of executing programs comprising:
loading a privileged host program including a hypervisor into an executable memory at a hypervisor memory datum byte physical address at or above a predetermined address;
loading into the executable memory, under a control of the hypervisor, a guest operating system program; and
allocating substantially all bytes of,the executable memory having physical addresses below the predetermined address to the guest operating system program.

2. The method of claim 1 further comprising the step of:
performing one or more DMA (Direct Memory Access) transfers directed by the guest operating system program.

3. The method of claim 2 wherein:
the predetermined address is approximately 16 Mebibytes.

4. The method of claim 2 further comprising the step of:
loading into the executable memory a privileged operating system program at a privileged operating system memory datum byte physical address higher than the hypervisor memory datum byte physical address.

5. The method of claim 2 further comprising:
executing the guest operating system program so that a selected one of the DMA transfers takes place at a plurality of physical addresses in RAM (random access memory) equal to addresses associated by the guest operating system program with the DMA selected transfer.

6. The method of claim 2 wherein:
the guest operating system program is operable to run in an unprivileged domain;
the privileged operating system program is operable to run in a privileged domain; and
the privileged operating system program is operable to emulate instructions executed by the guest operating system program.

7. The method of claim 2 wherein:
the DMA transfers are to or from a peripheral device connected via a PCI (peripheral channel interface) bus; and
the guest operating system program performs instructions for PIO (programmed input-output) transfers to the peripheral device.

8. A computer program product comprising:
at least one computer-readable medium having instructions encoded therein, the instructions when executed by at least one processor cause said at least one processor to
operate by steps comprising the acts of:
loading a privileged host program including a hypervisor into an executable memory at a hypervisor memory datum byte physical address at or above a predetermined address;
loading into the executable memory, under a control of the hypervisor, a guest operating system program; and
allocating substantially all bytes of the executable memory having physical addresses below the predetermined address to the guest operating system program.

9. The computer program product of claim 8 wherein:
the predetermined address is 16 Mebibytes.

10. The computer program product of claim 8 further comprising the act of:
loading into the executable memory a privileged operating system program at a privileged operating system memory datum byte physical address higher than the hypervisor memory datum byte physical address.

11. An electronic device comprising:
at least one controller; and
at least one non-volatile memory having instructions encoded therein, the instructions when executed by the controller cause said controller to operate by steps comprising the acts of:
loading a privileged host program including a hypervisor into an executable memory at a hypervisor memory datum byte physical address at or above a predetermined address;
loading into the executable memory, under a control of the hypervisor, a guest operating system program;
allocating substantially all bytes of the executable memory having physical addresses below the predetermined address to the guest operating system program; and
performing one or more DMA (Direct Memory Access) transfers directed by the guest operating system program.

12. The electronic device of claim 11 wherein:
the predetermined address is 16 Mebibytes.

13. The electronic device of claim 11 wherein the instructions when executed by the controller further cause said controller to
load into the executable memory a privileged operating system program at a privileged operating system memory datum byte physical address higher than the hypervisor memory datum byte physical address.
